(19) United States
(12) Patent Application Publication
(10) Pub. No.: US 2014/0058971 A1
(43) Pub. Date: Feb. 27, 2014

(54) CROSS-BORDER SHIPPING SOLUTION

(71) Applicants: Prakash Muppirala, San Jose, CA (US); Madhusudan Varadan, Fremont, CA (US); Sanjay Narang, Foster City, CA (US)

(72) Inventors: Prakash Muppirala, San Jose, CA (US); Madhusudan Varadan, Fremont, CA (US); Sanjay Narang, Foster City, CA (US)

(73) Assignee: EBAY INC., San Jose, CA (US)

(21) Appl. No.: 13/591,018

(22) Filed: Aug. 21, 2012

(51) Int. Cl. G06Q 50/28

(52) U.S. Cl. 705/333

(57) ABSTRACT

A cross-border shipping system is described. Information from a cross-border commercial transaction between a seller and a buyer for an item is accessed from an online marketplace. A virtual shipping carrier service is generated for the cross-border commercial transaction using at least one of the shipping carriers transparent to the seller and the buyer. A virtual tracking identifier is generated for the virtual shipping carrier service. The virtual tracking identifier identifies the cross-border commercial transaction and the corresponding shipping carriers.

### TECHNICAL FIELD

This application relates generally to the field of computer technology and, in a specific example embodiment, to a system and method for a cross-border shipping system.

### BACKGROUND

Websites provide a number of publishing, listing, and price-setting mechanisms whereby a publisher (e.g., a seller) may list or publish information concerning items for sale. Once a buyer places an order for an item, the seller fulfills the order by shipping the item to the buyer.

However, cross-border sellers and buyers are faced with a variety of tasks when the item ordered is being shipped internationally across multiple nations. Delays may arise from the multiple stops and transition of the item between the multiple stops. Furthermore, customs forms and codes further complicate and add inefficiency to the transaction.

### BRIEF DESCRIPTION OF THE DRAWINGS

The present description is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 is a block diagram illustrating an example embodiment of a cross-border shipping application;

FIG. 3 is a block diagram illustrating an example embodiment of a virtual shipping carrier module;

FIG. 4 is a block diagram illustrating an example embodiment of a virtual carrier tracking module;

FIG. 5 is a block diagram illustrating an example of a virtual shipping carrier having multiple shipping service providers;

FIG. 6 is a ladder diagram illustrating an example embodiment of an operation of the cross-border shipping application;

FIG. 7 is a flow diagram illustrating an example embodiment of a process for a cross-border shipping application;

FIG. 8 is a flow diagram illustrating an example embodiment of a method for generating different shipping options;

FIG. 9 is a flow diagram illustrating an example embodiment of a method for optimizing a shipping itinerary based on preference;

FIG. 10 is a flow diagram illustrating an example embodiment of a method for generating a shipping status;

FIG. 11 is a flow diagram illustrating an example embodiment of a method for generating custom forms; and

FIG. 12 shows a diagrammatic representation of a machine in the example form of a computer system within which a set of instructions may be executed to cause the machine to perform any one or more of the methodologies discussed herein.

### DETAILED DESCRIPTION

Although the embodiments have been described with reference to specific example embodiments, it will be evident that various modifications and changes may be made to these embodiments without departing from the broader spirit and scope of the description. Accordingly, the specification and drawings are to be regarded in an illustrative rather than a restrictive sense.

In various embodiments, a cross-border shipping system is described. Information from a cross-border commercial transaction between a seller and a buyer for an item is accessed from an online marketplace. A virtual shipping carrier service is generated for the cross-border commercial transaction using at least one of the shipping carriers transparent to the seller and the buyer. Information from the cross-border commercial transaction and from the plurality of shipping carriers is stored. A virtual tracking identifier is generated for the virtual shipping carrier service. The virtual tracking identifier identifies the cross-border commercial transaction and the corresponding shipping carriers. Cross-border may include countries, states, provinces, political, or geographical borders.

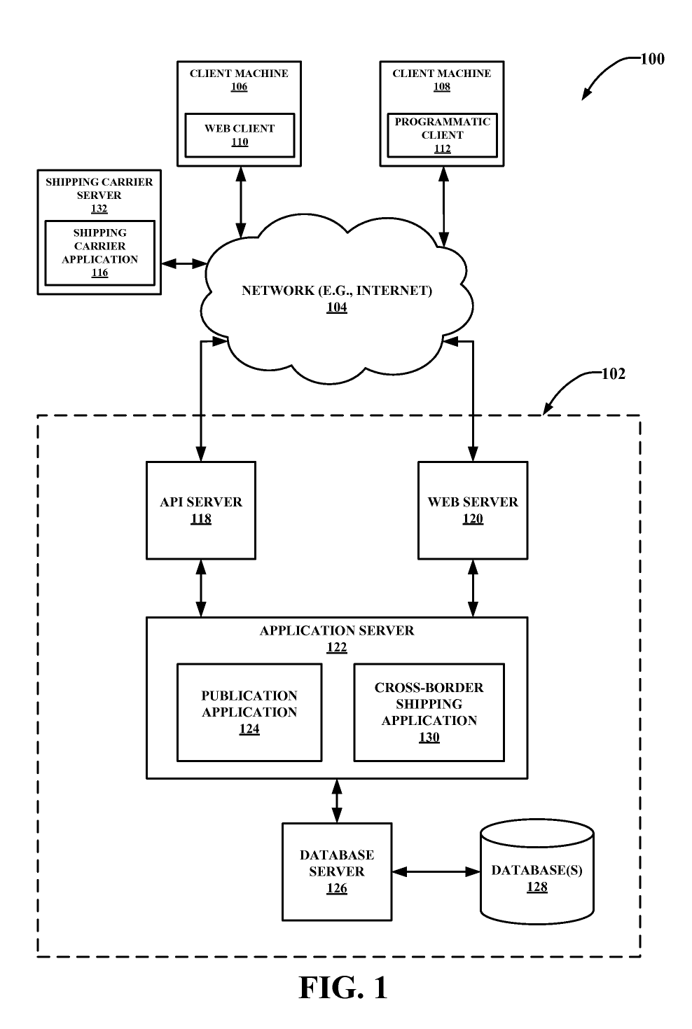

FIG. 1 is a network diagram depicting a network system 100, according to one embodiment, having a client-server architecture configured for exchanging data over a network. For example, the network system 100 comprises a network-based publisher 102, where clients may communicate and exchange data within the network system 100. The data may pertain to various functions (e.g., online item purchases) and aspects (e.g., managing order information) associated with the network system 100 and its users. Although illustrated herein as a client-server architecture as an example, other embodiments may include other network architectures, such as a peer-to-peer or distributed network environment.

A data exchange platform, in an example form of the network-based publisher 102, may provide server-side functionality, via a network 104 (e.g., the Internet), to one or more clients. The one or more clients may include users that utilize the network system 100 and, more specifically, the network-based publisher 102, to exchange data over the network 104. These transactions may include transmitting, receiving (communicating), and processing data to, from, and regarding content and users of the network system 100. The data may include, but are not limited to, content and user data such as order and shipping tracking information; item information; user profiles; user attributes; user reputation values; product and service reviews and information (such as pricing and descriptive information); product, service, manufacturer, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client (e.g., web browser) 110. The web client 110 may be in communication with the network-based publisher 102 via a web server 120. The UIs may also be associated with a client machine 108 using a programmatic client 112, such as a client application. It can be appreciated that in various embodiments, the client machines 106 and 108 may be associated with a buyer, a seller, a third-party electronic commerce platform, and/or a payment service provider. The buyers and sellers may be any one of individuals, merchants, or service providers, among other things.

Furthermore, a shipping carrier server 132 of a shipping service provider may be in communication with the network-based publisher 102 and optionally with client machines 106 and 108. The shipping carrier server 132 includes a shipping carrier application 116 to provide a shipping tracking mechanism to the client machines 106 and 108 and an application server 122 of the network-based publisher 102. The shipping tracking mechanism allows the client machines 106 and 108 and the application server 122 to determine a status or current location of a shipment for an item associated with an order placed by a buyer of the network-based publisher 102.

Turning specifically to the network-based publisher 102, an application program interface (API) server 118 and a web server 120 are coupled to, and provide programmatic and web interfaces respectively to, one or more application servers 122. The application servers 122 host a publication application 124 and a cross-border shipping application 130. The application servers 122 are, in turn, shown to be coupled to one or more database server(s) 126 that facilitate access to one or more database(s) 128.

In one embodiment, the web server 120 and the API server 118 communicate about and receive data pertaining to listings, transactions, order tracking information, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., web client 110 or shipping carrier application 116) running on another client machine (e.g., shipping carrier server 132).

The publication application 124 may provide a number of publisher functions and services (e.g., listing, payment, etc.) to users that access the network-based publisher 102. For example, the publication application 124 may provide a number of services and functions to users for listing goods and/or services for sale, facilitating transactions, and reviewing and providing feedback about transactions and associated users. The publication application 124 may further report a shipment status related to a transaction. In one embodiment, the publication application 124 includes an online marketplace that generates a commercial transaction between a seller and a buyer for an item listed in the online marketplace.

The cross-border shipping application 130 generates a personalized delivery time estimate to a buyer of the online marketplace for an item sold by a seller. The personalized delivery time estimate may include a date and time estimate, a range of dates, and a range of dates and times. The cross-border shipping application 130 may generate a virtual shipping carrier service for cross-border commercial transactions. An embodiment of the cross-border shipping application 130 is further described below.

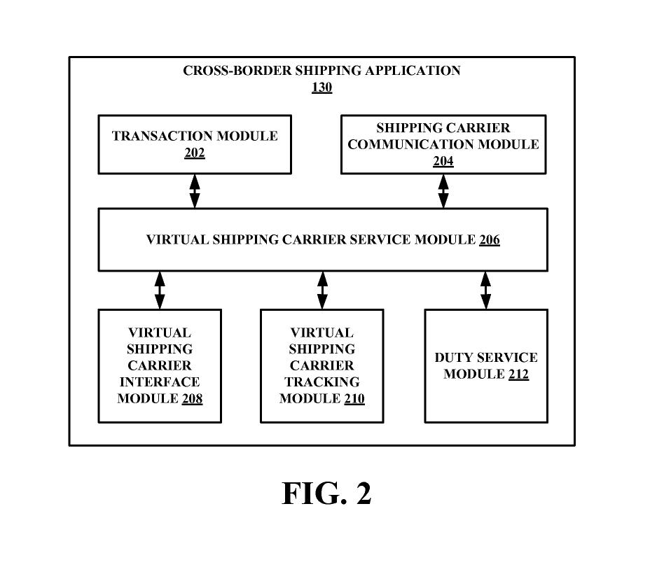

FIG. 2 is a block diagram illustrating an example embodiment of the cross-border shipping application 130. In one embodiment, the cross-border shipping application 130 includes a transaction module 202, a shipping carrier communication module 204, a virtual shipping carrier service module 206, a virtual shipping carrier interface module 208, a virtual shipping carrier tracking module 210, and a duty service module 212.

The transaction module 202 may access information from a cross-border commercial transaction between a seller and a buyer for an item in an online marketplace. In one embodiment, the transaction module 202 may access the publication application 124 (FIG. 1) to access or retrieve seller information including, for example, a seller's shipping address; buyer information including, for example, buyer's shipping address; information concerning the item to be shipped including, for example, the nature of the item; and weight and dimensions of the item.

The shipping carrier communication module 204 communicates with shipping carriers to access, for example, shipping time and cost estimates, shipping routes, shipping services, and shipping schedules from the corresponding shipping carriers. In one embodiment, the publication application 124 identifies predefined or preapproved shipping carriers. For example, the shipping carrier communication module 204 communicates with a shipping carrier server, such as shipping carrier server 132 (FIG. 1), corresponding to the shipping carrier.

The virtual shipping carrier service module 206 computes a shipping itinerary for the virtual shipping carrier service for the item in the cross-border commercial transaction from a combination of the shipping carriers. The shipping itinerary may include different legs of the shipping route where different shipping carriers perform different shipping legs. For example, the shipping itinerary may include the number of shipping legs, the name of the shipping carrier corresponding to each shipping leg, the total shipping distance, the total shipping cost, the total shipping time, the shipping distance for each shipping leg, the shipping cost for each leg, the shipping time for each shipping leg, and the transit location corresponding to each leg. The term “shipping itinerary” may be used interchangeably with “shipping route” in the present disclosure. In one embodiment, a storage device stores information from the cross-border commercial transaction and from the shipping carriers.

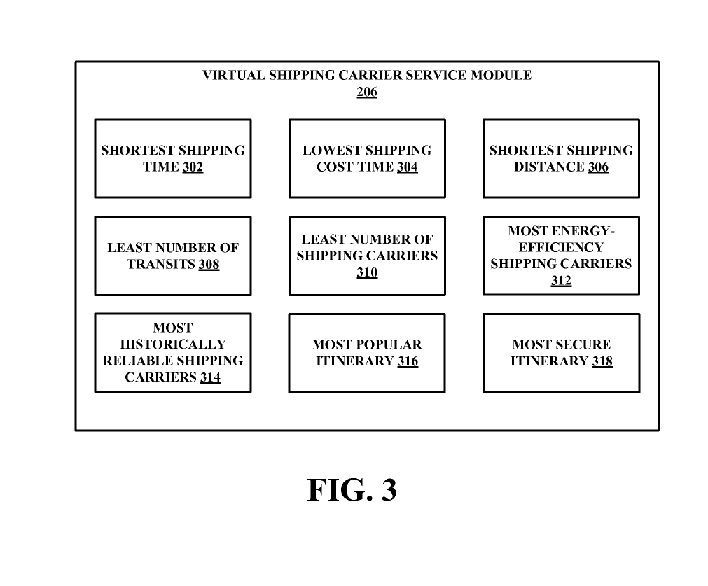

In another embodiment, the virtual shipping carrier service module 206 optimizes the shipping itinerary based on a shipping preference. FIG. 3 illustrates different example of shipping preferences modules: shortest shipping time module 302, lowest shipping cost module 304, shortest shipping distance module 306, least number of transits module 308, least number of shipping carriers module 310, most energy-efficient (“green”) shipping carriers module 312, most historically reliable shipping carriers module 314, most popular itinerary module 316, and most secure itinerary module 318.

The shortest shipping time module 302 may optimize the shipping route by using different shipping carriers and shipping legs to have the shortest total shipping time from the seller to the buyer.

The lowest shipping cost module 304 may optimize the shipping route by using different shipping carriers and shipping legs to have the total lowest shipping cost.

The shortest shipping distance module 306 may optimize the shipping route by using different shipping carriers and shipping legs to have the shortest total shipping distance.

The least number of transits module 308 may optimize the shipping route by using different shipping carriers and shipping legs to have the least total number of transits.

The least number of shipping carriers module 310 may optimize the shipping route by using different shipping carriers and shipping legs to have the least total number of shipping carriers.

The most energy-efficient (“green”) shipping carriers module 312 may optimize the shipping route by using different shipping carriers and shipping legs to have the most energy-efficient shipping carriers. In other words, shipping carriers selected for the shipping route may have a track record of taking steps towards reducing carbon emission.

The most historically reliable shipping carriers module 314 may optimize the shipping route by using different shipping carriers and shipping legs to select the most historically reliable shipping carriers based on historical performance data. The historical performance data may include, for example, a percentage of on-time delivery. In one embodiment, the historical performance data may be collected directly from the shipping carrier. In another embodiment, the historical performance data may be gathered from shipping transactions recorded by the publication application 124.

The most popular itinerary module 316 may optimize the shipping route by using different shipping carriers and shipping legs to select the most popular route for the item to be shipped. For example, popular transit locations may include popular hub locations or key locations, such as major metropolitan cities.

The most secure itinerary module 318 may optimize the shipping route by using different shipping carriers and shipping legs to select the most secure route for the item to be shipped. For example, the shipping route may include detours through countries that are considered most safe for a valuable item to avoid certain areas deemed unsafe.

Referring back to FIG. 2, in yet another embodiment, the virtual shipping carrier service module 206 computes several shipping itineraries using different combinations of the shipping carriers based on the shortest shipping time and the lowest shipping cost. The different shipping itineraries are then presented to the seller for the virtual shipping carrier.

The virtual shipping carrier interface module 208 generates a virtual shipping carrier service for the cross-border commercial transaction using at least one of the of shipping carriers that are transparent to the seller and the buyer. In other words, neither the seller nor the buyer can directly identify the individual shipping carriers made up for the cross-border commercial transaction. The virtual shipping carrier service acts as a virtual single shipping carrier for the selected individual shipping carriers.

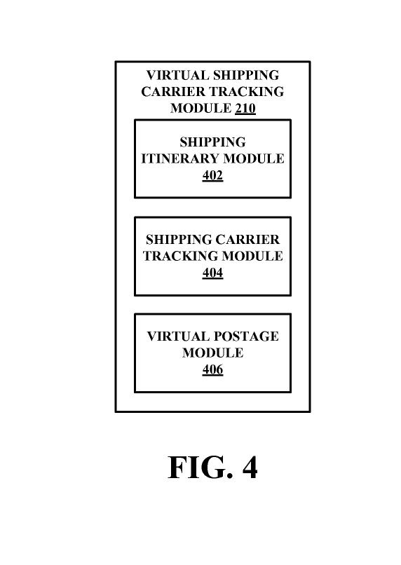

The virtual shipping carrier tracking module 210 generates a tracking identifier for the virtual shipping carrier service. For example, the tracking identifier identifies the cross-border commercial transaction and the corresponding shipping carriers. FIG. 4 is a block diagram illustrating an example embodiment of the virtual shipping carrier tracking module 210. The virtual shipping carrier tracking module 210 includes a shipping itinerary module 402, a shipping carrier tracking module 404, and a virtual postage module 406.

The shipping itinerary module 402 uses, for example, the virtual tracking identifier to access the shipping itinerary and to identify the shipping carriers corresponding to the shipping itinerary.

The shipping carrier tracking module 404 accesses the corresponding shipping carriers for a shipping status. Once the shipping carrier tracking module 404 receives the individual shipping status from each shipping carrier, the shipping carrier tracking module 404 aggregates the shipping tracking details from the different shipping carriers and generates a shipping status from the virtual shipping carrier service without having to identify the different shipping carriers.

The virtual postage module 406 generates a single computer-readable code corresponding to the shipping itinerary to be identified across the plurality of shipping carriers for postage payment. For example, the virtual postage can enable a shipped package to be identified by multiple shipping carriers for seamless package transits. The computer-readable code may include, for example, a Quick Response (QR) code, or any other machine-readable bar code.

Referring back to FIG. 2, the duty service module 212 accesses the cross-border commercial transaction. In one embodiment, the duty service module 212 then generates harmonization codes using details from the cross-border commercial transaction. The harmonization codes are used to generate electronic customs forms based on details from the cross-border commercial transaction to the corresponding shipping carriers.

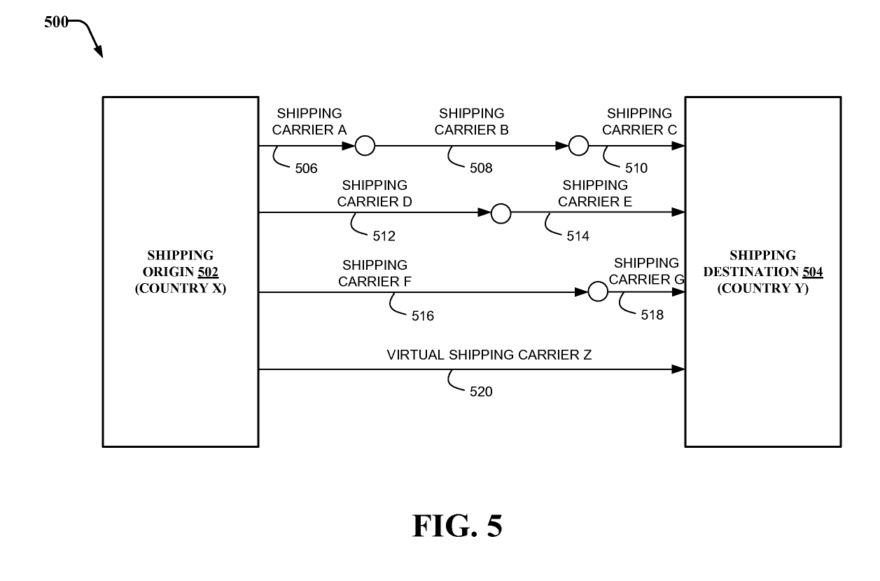

FIG. 5 is a block diagram illustrating an example 500 of a virtual shipping carrier having multiple shipping service providers. An item is to be shipped from a shipping origin 502 to a shipping destination 504 based on a cross-border commercial transaction. The location of the shipping origin 502 may be, for example, in country X. The location of the shipping destination 504 may be, for example, in a different country: country Y.

Multiple routes can be used to ship the item from the shipping origin 502 to the shipping destination 504. For example, a first shipping itinerary may include three legs: a shipping carrier A corresponding to a first leg 506, a shipping carrier B corresponding to a second leg 508, and a shipping carrier C corresponding to a third leg 510. A second shipping itinerary may include two legs: a shipping carrier D corresponding to a first leg 512, and a shipping carrier E corresponding to a second leg 514. A third shipping itinerary may include two legs: a shipping carrier F corresponding to a first leg 516, and a shipping carrier G corresponding to a second leg 518. In the previous example, the transit location between shipping carrier D and shipping carrier E is further away from the shipping destination 504 than the transit location between shipping carrier F and shipping carrier G.

For example, the first shipping itinerary may correspond to a most secure shipping route. The second shipping itinerary may correspond to a fast shipping time. The third shipping itinerary may correspond to the lowest shipping cost.

The virtual shipping carrier Z provides the ability to integrate internally with multiple shipping carriers to create a uniform tracking experience. For example, the virtual shipping carrier Z creates a unique code once the item is picked up from the seller and will work with multiple carriers internally to aggregate their shipping tracking details to create a uniform tracking experience to the end users (e.g., buyers and sellers). The multiple shipping carriers are transparent to the end users who only interact with the virtual shipping carrier Z with one shipping route 520.

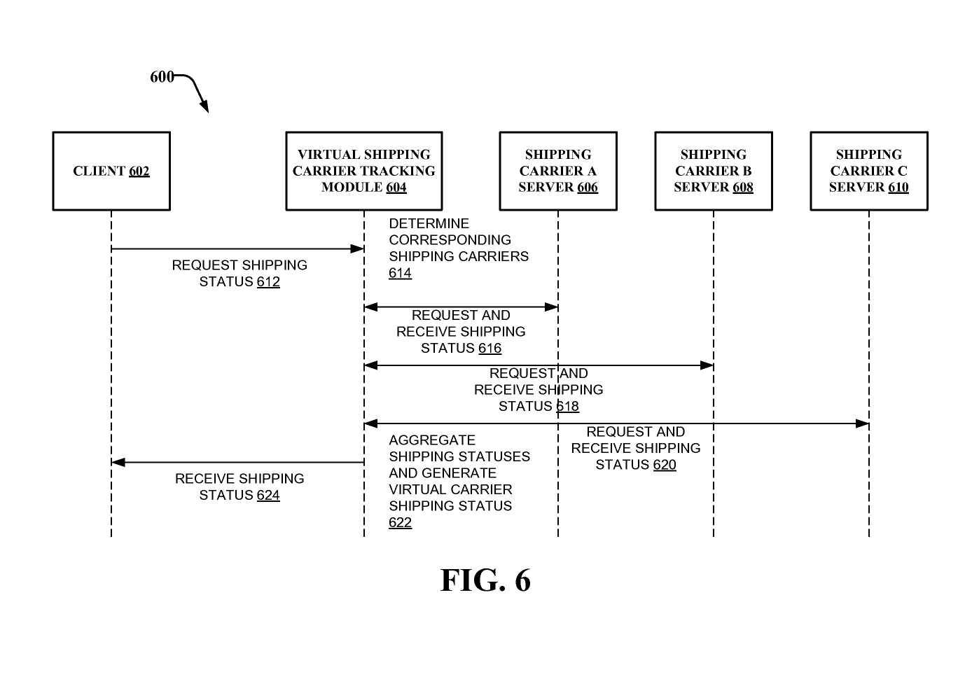

FIG. 6 is a ladder diagram illustrating an example embodiment of an operation 600 of the cross-border shipping application 130. A client 602 submits a request for a shipping status 612 concerning an item shipped corresponding to a cross-border commercial transaction between a buyer and a seller from an online marketplace to a virtual shipping carrier tracking module 604 of the cross-border shipping application 130. In one embodiment, the client 602 submits a tracking identifier corresponding to the virtual shipping carrier service as provided by the virtual shipping carrier tracking module 210 of FIG. 2.

The virtual shipping carrier tracking module 604 determines the corresponding shipping carriers associated with the request for a shipping status 612 at operation 614 using the tracking identifier provided by the client 602. Once the corresponding shipping carriers have been determined, the virtual shipping carrier tracking module 604 submits a request for shipping status to each corresponding shipping carrier server. For example, the virtual shipping carrier tracking module 604 submits a shipping status request 616, 618, 620 to corresponding shipping carrier A server 606, shipping carrier B server 608, and shipping carrier C server 610.

Once the virtual shipping carrier tracking module 604 receives the shipping status requests 616, 618, 620 from shipping carrier A server 606, shipping carrier B server 608, and shipping carrier C server 610, it aggregates the different shipping statuses and generates a virtual carrier shipping status at operation 622. The client 602 then receives, at operation 624, the virtual carrier shipping status transparent to the different shipping carriers A, B, and C.

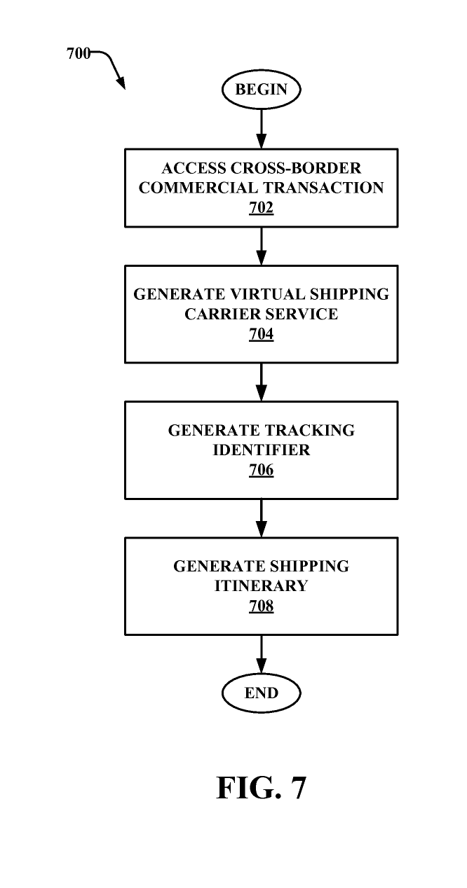

FIG. 7 is a flow diagram illustrating an example embodiment of a process 700 for a cross-border shipping application. At operation 702, information from a cross-border commercial transaction between a seller and a buyer for an item in an online marketplace (e.g., generated by publication application 124) is accessed or retrieved. In one embodiment, the transaction module 202 of cross-border shipping application 130 accesses the information from the cross-border commercial transaction.

At operation 704, a virtual shipping carrier service is generated for the cross-border commercial transaction using at least one of the shipping carriers that are transparent to the seller and the buyer. In one embodiment, the virtual shipping carrier service module 206 generates a virtual shipping carrier service for the end users.

At operation 706, a tracking identifier is generated for the virtual shipping carrier service. The tracking identifier may identify the cross-border commercial transaction and the corresponding shipping carriers. In one embodiment, the virtual shipping carrier tracking module 210 generates the tracking identifier.

At operation 708, a shipping itinerary for the virtual shipping carrier service for the item in the cross-border commercial transaction is computed from a combination of the shipping carriers. In one embodiment, the virtual shipping carrier service module 206 generates the shipping itinerary.

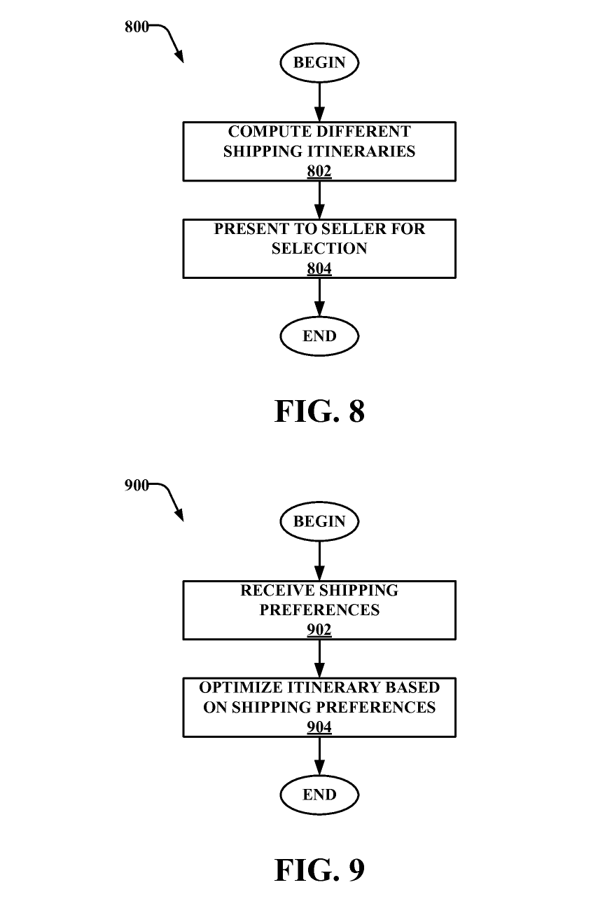

FIG. 8 is a flow diagram illustrating an example embodiment of a method 800 for generating different shipping options. At operation 802, at least one shipping itinerary using different combinations of the shipping carriers is computed. At operation 804, one or more shipping itineraries are presented to the end users. For example, one shipping itinerary may be presented as “shipping option A has a shipping cost of x dollars and an approximate shipping time of x days.”

FIG. 9 is a flow diagram illustrating an example embodiment of a method 900 for optimizing a shipping itinerary based on preference. At operation 902, the virtual shipping carrier service module 206 may present different shipping preferences to the end users. The end users may select the shipping preference. For example, the shipping preferences may include: the fast total shipping time, the lowest total shipping cost, the lowest number of total shipping transits, the shortest total shipping distance, the shortest amount of shipping carriers, the most energy-efficient shipping carriers, the most reliable shipping carriers, the most popular route based on the cross-border commercial transaction, and the most secure route.

At operation 904, a shipping itinerary is optimized using the selected shipping preference. In one embodiment, the virtual shipping carrier service module 206 optimizes the shipping itinerary using the selected shipping preference.

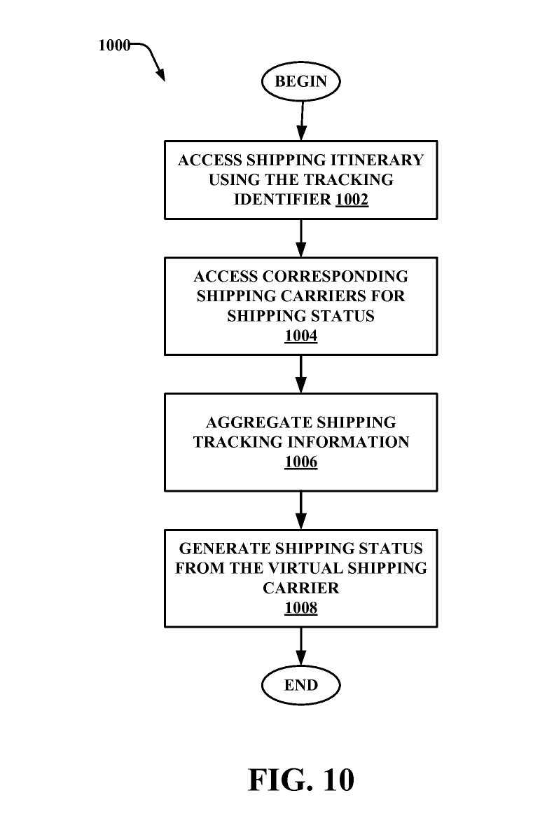

FIG. 10 is a flow diagram illustrating an example embodiment of a method 1000 for generating a shipping status. At operation 1002, the shipping itinerary module 402 (FIG. 4) uses a virtual tracking identifier to access the shipping itinerary from the cross-border commercial transaction and to identify the shipping carriers corresponding to the shipping itinerary. At operation 1004, the shipping itinerary module 402 accesses the corresponding shipping carriers for a shipping status. At operation 1006, the shipping itinerary module 402 aggregates shipping tracking details and status (e.g., current location and time, expected delivery time for shipping leg, etc.) from the shipping carriers.

At operation 1008, the shipping itinerary module 402 generates a shipping status from the virtual shipping carrier service. In another embodiment, the shipping itinerary module 402 generates a single computer-readable code corresponding to the shipping itinerary to be identified across the plurality of shipping carriers for postage payment.

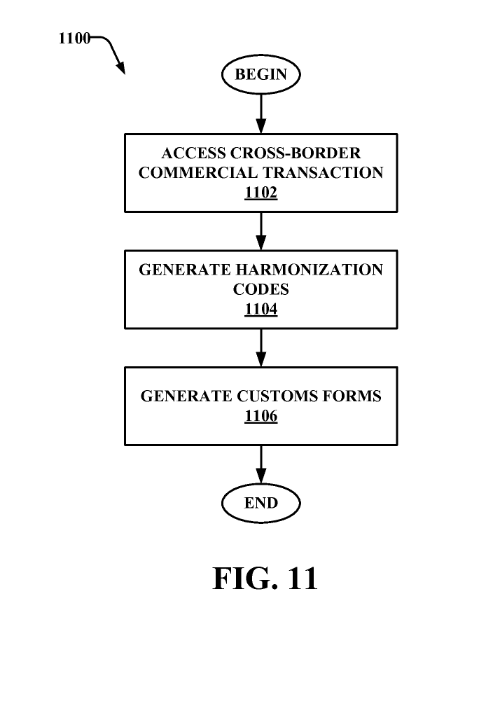

FIG. 11 is a flow diagram illustrating an example embodiment of a method 1100 for generating customs forms. At operation 1102, the duty service module 212 accesses the cross-border commercial transaction. At operation 1104, the duty service module 212 generates harmonization codes using details from the cross-border commercial transaction. At operation 1106, the duty service module 212 generates electronic customs forms based on the harmonization codes and details from the cross-border commercial transaction to the corresponding shipping carriers.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Example Computer System

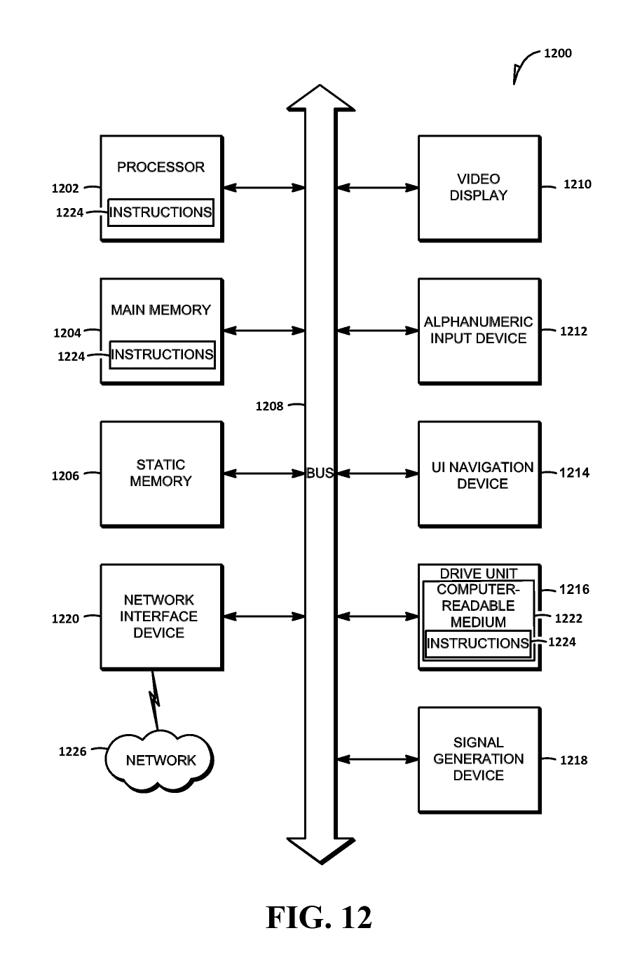

FIG. 12 shows a diagrammatic representation of a machine in the example form of a computer system 1200 within which a set of instructions 1224 may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a UI navigation device 1214 (e.g., a mouse), a disk drive unit 1216, a signal generation device 1218 (e.g., a speaker) and a network interface device 1220.

The disk drive unit 1216 includes a computer-readable medium 1222 on which is stored one or more sets of instructions 1224 and data structures (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting machine-readable media.

The instructions 1224 may further be transmitted or received over a network 1226 via the network interface device 1220 utilizing any one of a number of well-known transfer protocols (e.g., HTTP).

While the computer-readable medium 1222 is shown in an example embodiment to be a single medium, the term “computer-readable medium” should be taken to include a single medium or multiple media (e.g., a centralized or distributed database, and/or associated caches and servers) that stores the one or more sets of instructions 1224. The term “computer-readable medium” shall also be taken to include any medium that is capable of storing, encoding or carrying a set of instructions for execution by the machine and that cause the machine to perform any one or more of the methodologies of the present description or that is capable of storing, encoding or carrying data structures utilized by or associated with such a set of instructions. The term “computer-readable medium” shall accordingly be taken to include, but not be limited to, solid-state memories, optical media, and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A cross-border shipping system comprising:
a transaction module configured to access information from a cross-border commercial transaction between a seller and a buyer for an item in an online marketplace;
a virtual shipping carrier service module configured to generate a virtual shipping carrier service for the cross-border commercial transaction using at least one of a plurality of shipping carriers that are transparent to the seller and the buyer;
a storage device configured to store information from the cross-border commercial transaction and from the plurality of shipping carriers; and
a virtual shipping carrier tracking module configured to generate a tracking identifier for the virtual shipping carrier service, the tracking identifier identifying the cross-border commercial transaction and corresponding shipping carriers.

2. The cross-border shipping system of claim 1, wherein the virtual shipping carrier service module is configured to compute a shipping itinerary for the virtual shipping carrier service for the item in the cross-border commercial transaction from a combination of the plurality of shipping carriers, the cross-border commercial transaction comprising an international border commercial transaction or a state border commercial transaction.

3. The cross-border shipping system of claim 2, wherein the virtual shipping carrier service module is configured to optimize the shipping itinerary using a shipping preference.

4. The cross-border shipping system of claim 1, wherein the virtual shipping carrier service module is configured to compute a plurality of shipping itineraries using different combinations of the plurality of shipping carriers.

5. The cross-border shipping system of claim 2, wherein the virtual shipping carrier service module is configured to optimize the shipping itinerary with a fast total shipping time, a lowest total shipping cost, a lowest number of total shipping transits, a shortest total shipping distance, a least amount of shipping carriers, or most energy-efficient shipping carriers.

6. The cross-border shipping system of claim 2, wherein the virtual shipping carrier service module is configured to optimize the shipping itinerary with: most reliable shipping carriers, most popular route based on the cross-border commercial transaction, or most secure route.

7. The cross-border shipping system of claim 2, wherein the virtual shipping carrier tracking module further comprises:
a shipping itinerary module configured to use the tracking identifier to access the shipping itinerary and to identify shipping carriers corresponding to the shipping itinerary; and
a shipping carrier tracking module configured to access the corresponding shipping carriers for a shipping status, to aggregate shipping tracking details from the shipping carriers, and to generate a shipping status from the virtual shipping carrier service.

8. The cross-border shipping system of claim 2, wherein the virtual shipping carrier tracking module further comprises:
a virtual postage module configured to generate a single computer-readable code corresponding to the shipping itinerary to be identified across the plurality of shipping carriers for postage payment.

9. The cross-border shipping system of claim 1, further comprising:
a shipping carrier communication module configured to communicate with the plurality of shipping carriers to access shipping time and cost estimates, shipping routes, shipping services, and shipping schedules.

10. The cross-border shipping system of claim 1, further comprising:
a duty service module configured to access the cross-border commercial transaction, to generate harmonization codes using details from the cross-border commercial transaction, and to generate electronic customs form based on the harmonization codes and details from the cross-border commercial transaction to the corresponding shipping carriers.

11. The cross-border shipping system of claim 1, further comprising:
a virtual shipping carrier interface module configured to provide a single shipping carrier shipping platform to the buyer and the seller, and to present a plurality of shipping options based on combinations of shipping carriers that are transparent to the buyer and the seller.

12. A computer-implemented method comprising:
accessing information from a cross-border commercial transaction between a seller and a buyer for an item in an online marketplace;
generating a virtual shipping carrier service for the cross-border commercial transaction using at least one of a plurality of shipping carriers that are transparent to the seller and the buyer;
storing information from the cross-border commercial transaction and from the plurality of shipping carriers in a storage device; and
generating, using a processor, a tracking identifier for the virtual shipping carrier service, the tracking identifier identifying the cross-border commercial transaction and corresponding shipping carriers.

13. The computer-implemented method of claim 12, further comprising:
computing a shipping itinerary for the virtual shipping carrier service for the item in the cross-border commercial transaction from a combination of the plurality of shipping carriers, the cross-border commercial transaction comprising an international border commercial transaction or a state border commercial transaction.

14. The computer-implemented method of claim 13, further comprising:
optimizing the shipping itinerary using a shipping preference.

15. The computer-implemented method of claim 12, further comprising:
computing a plurality of shipping itineraries using different combinations of the plurality of shipping carriers.

16. The computer-implemented method of claim 13, further comprising:
optimizing the shipping itinerary with: a fast total shipping time, a lowest total shipping cost, a lowest number of total shipping transits, a shortest total shipping distance, a shortest amount of shipping carriers, most energy-efficient shipping carriers, most reliable shipping carriers, a most popular route based on the cross-border commercial transaction, or a most secure route.

17. The computer-implemented method of claim 13, further comprising:
using the tracking identifier to access the shipping itinerary and to identify shipping carriers corresponding to the shipping itinerary;
accessing the corresponding shipping carriers for a shipping status;
aggregating shipping tracking details from the shipping carriers;
generating a shipping status from the virtual shipping carrier service; and
generating a single computer-readable code corresponding to the shipping itinerary to be identified across the plurality of shipping carriers for postage payment.

18. The computer-implemented method of claim 13, further comprising:
accessing the cross-border commercial transaction;
generating harmonization codes using details from the cross-border commercial transaction; and
generating electronic customs form based on the harmonization codes and details from the cross-border commercial transaction to the corresponding shipping carriers.

19. The computer-implemented method of claim 12, further comprising:
providing a single shipping carrier shipping platform to the buyer and the seller; and
presenting a plurality of shipping options based on combinations of shipping carriers that are transparent to the buyer and the seller.

20. A non-transitory computer-readable storage medium storing a set of instructions that, when executed by a processor, cause the processor to perform operations, comprising:
accessing information from a cross-border commercial transaction between a seller and a buyer for an item in an online marketplace;
generating a virtual shipping carrier service for the cross-border commercial transaction using at least one of a plurality of shipping carriers that are transparent to the seller and the buyer;
storing information from the cross-border commercial transaction and from the plurality of shipping carriers; and
generating a tracking identifier for the virtual shipping carrier service, the tracking identifier identifying the cross-border commercial transaction and corresponding shipping carriers.
